(19) United States
(12) Patent Application Publication
(10) Pub. No.: US 2021/0009404 A1
(43) Pub. Date: Jan. 14, 2021

(54) HOT REFUELING SYSTEMS AND METHODS

(71) Applicant: GREEN ENERGY SERVICES INC., Calgary (CA)

(72) Inventors: Garnet OLSON, Calgary (CA); Glynn BATES, Calgary (CA); Darryl Reese, Red Deer County (CA)

(21) Appl. No.: 16/926,464

(22) Filed: Jul. 10, 2020

Related U.S. Application Data
(60) Provisional application No. 62/872,897, filed on Jul. 11, 2019.

(51) Int. Cl. B67D 7/36; B67D 7/04; B67D 7/38

(52) U.S. Cl. CPC B67D 7/365; B67D 7/38; B67D 7/04

(57) ABSTRACT

Systems and methods for hot refueling from a fuel source to one or more fuel tanks associated with equipment in the hot zone of a well site. Automatic valves are located at the fuel tanks, obviating the need for electronic communication in or out of the hot zone. A flexible conduit or hose is connected between one or more outlet ports of the fuel source to corresponding one or more automatic valves at the fuel tanks. The valve, such as a float-type valve, uses fuel level to open the valve whenever the fuel tank is below a full fuel level threshold. Fuel levels at or above the full fuel level threshold automatically close the valve.

### CROSS-REFERENCE TO RELATED APPLICATIONS

This application claims the benefit of U.S. Provisional Patent application Ser. No. 62/872,897, filed Jul. 11, 2019, the entirety of which is incorporated herein by reference.

### FIELD

This disclosure relates to systems and methods for hot refueling of one or more pieces of equipment while they are in operation, using fuel level control valves at each fuel tank, obviating the need for human operators in the “hot zone” or need for electrical communication between the fuel tank and fuel source.

### BACKGROUND

Hydraulic fracturing is a well stimulation technique in which rock is fractured by a pressurized liquid. The process involves the high-pressure injection of fracturing fluid, often containing suspended sand or other proppants, into a wellbore to create cracks or fractures in the deep rock formations, through which hydrocarbons will flow more freely to a production wellbore.

Hydraulic fracturing operations generally require large numbers of portable equipment which consume large quantities of diesel fuel. Ideally, the portable equipment is run continuously to avoid untimely and costly interruptions during the hydraulic fracturing operation.

Accordingly, the portable equipment is refueled while operational. Prior to the use of automated systems, refueling was performed manually with a worker physically refueling a fuel tank of the portable equipment, in the hot zone, with a hand valve and nozzle system similar to those found at typical commercial motor vehicle gas refueling stations. Manual hot refueling can be a dangerous task in particular with the risk of ignition sources in the presence of fuel vapors and ultimately fire.

Further, there are numerous other potential health and safety hazards associated with manual hot refueling including hazards relating to: (i) exposure to very high noise levels, requiring workers to wear substantial hearing protection; (ii) having to operate in confined spaces; (iii) exposure to diesel vapors when fuel caps are removed, with engine exhaust and general poor air quality; (iv) heat stress as the portable equipment operates at very high temperatures; and (v) spills representing health, safety and environmental concerns.

More recently, automated systems have been developed that allow remote hot refueling that does not require a human operator to be near the portable equipment in the “hot zone”. As shown in FIG. 1, prior art automated systems typically have an electrically-operable, automatic valve located at the fuel source for controlling fuel flow into and through a hose that extends into the hot zone and is connected to the fuel tank of the portable equipment. These automated systems also utilize a fuel level sensor located at the fuel tank of the portable equipment, which communicates out of the hot zone to the remote automatic valve. Using the information from the fuel level sensor, the automated systems can control the fluid flow through each of the hoses based upon instruction from either an electronic controller or a human operator.

Alternatively, refueling was also performed using a continuous circulation system where a first equipment fuel tank is connected and receives fuel from a fuel supply. The first equipment fuel tank also has an outlet that is connected as an input to a second equipment fuel tank with fuel in the first equipment fuel tank above a threshold level being transferred to the second equipment fuel tank. The second equipment fuel tank has an outlet that is connected as an input to a third equipment fuel tank. This configuration continues with an outlet of a final equipment fuel tank returning fuel to the fuel supply. A continuous circulation system has increased complexity, has interdependence among equipment fuel tanks and requires continuous pumping of fuel.

While these automated systems address many of the safety issues associated with manual hot refueling, they have increased complexity and come at higher costs. Some of such systems implement an electrically-controlled valve at the fuel source, outside the hot zone, and a fuel level sensor at the fuel tank, in the hot zone, with electronic communication therebetween, including wireless communications, for control of the valve. The electronic components are subject to software and hardware failure while wireless communications are subject to interference issues. Alternatively in lieu of an electrically-operated valve, a human operator opening and closing a valve, acting on fuel tank sensor communications, is subject to mistakes. The continuous circulation systems also require continuous pumping of fuel, have increased complexity, and have interdependence among equipment fuel tanks since if the connections of one fuel tank fail, the remaining fuel tanks will be affected. These features all have associated equipment and maintenance costs and each introduces another possible point of failure.

There is an ongoing desire for an automated hot refueling system with lower operating costs and fewer opportunities for failure.

### SUMMARY

Generally, Applicant provides a refueling system that avoids personnel entry into the hot zone through localized fluid level control at the fuel tank. As a result, the refueling system need not use electronic sensors, nor electric, or electronic, forms of electronic communication to electrically-operated valves inside or outside of the hot zone.

In one broad aspect, a hot refueling system for refueling a fuel tank of operating equipment at a well site has a fuel source, a conduit and a fuel tank inlet. The fuel source has at least one fuel source outlet. The conduit extends from the at least one fuel source outlet to a fuel tank inlet of the fuel tank, for delivery of fuel to the fuel tank. The fuel tank inlet comprising a valve that has an open position allowing a flow of fuel into the fuel tank when fuel level in the fuel tank is below a full fuel level threshold and a closed position preventing the flow of fuel into the fuel tank when fuel level in the fuel tank is at or above the full fuel level threshold. The valve automatically cycles between the open position and the closed position in response to fuel level in the fuel tank.

In an embodiment, the system has a plurality of fuel tanks and a plurality of conduits. The fuel source has a manifold having two or more fuel source outlets and one of the plurality of conduits extends from each fuel source outlet to an inlet of one of the plurality of fuel tanks.

In an embodiment, the system has a pump to deliver fuel from the fuel source to the fuel tank.

In an embodiment, the conduit is armored and flexible.

In an embodiment, the valve is a float-type valve that has a float responsive to fuel level in the fuel tank. The valve closes when the float is at or above the full fuel level threshold and opens when the float is below the full fuel level threshold.

In an embodiment, the valve has a conduit extending into the fuel tank inlet, the conduit restraining the float therein and further comprising a seat, the float sealing the seat when fuel level is at or above the full fuel level threshold.

In an embodiment, the valve is a pressure-sensitive valve responsive to pressure in the fuel tank. The valve closes at or above a pressure corresponding to the full fuel level threshold and opens at a pressure below the pressure corresponding to the full fuel level threshold.

In an embodiment, the fuel source further has a manual valve arrangement located outside of the hot zone, to shut off the flow of fuel into the at least one conduit.

In an embodiment, each fuel outlet has a manual valve arrangement located outside of the hot zone, to shut off the flow of fuel into a conduit extending therefrom.

In an embodiment, a manifold connects a plurality of fuel sources to the fuel source outlet.

In an embodiment, the system has a manual fluid flow meter for the fuel source.

In an embodiment, the system has a manual fluid flow meter for the fuel tank.

In an embodiment, the system has a rate of flow meter for the fuel tank.

In an embodiment, the system has a fuel pressure sensor for the fuel tank.

In an embodiment the system has a time-based controller that controls the flow of fuel from the fuel source to the fuel tank on a time schedule.

In an embodiment, the system of claim 1, wherein the full fuel level threshold is between 90% to 95% of a physical capacity of the fuel tank.

In another broad aspect, a method of delivering fuel to at least one fuel tank of equipment at a well site is provided. The method includes pumping fuel from a fuel source into a conduit and from the conduit into the at least one fuel tank and controlling fluid flow from the conduit into the at least one fuel tank with a valve that is responsive to fuel level in the fuel tank. The valve automatically opens when fuel level in the fuel tank is below a full fuel level threshold and automatically closes when fuel level in the fuel tank is at or above the full fuel level threshold.

In an embodiment, the fuel is pumped at a specified time for a specified duration.

In an embodiment, fuel is pumped periodically for a specified time followed by a user specified delay.

In an embodiment, the full fuel level threshold is set between 90% to 95% of the physical capacity of the at least one fuel tank.

### BRIEF DESCRIPTION OF THE DRAWINGS

FIG. 1 is a schematic of a remote, automatic valve operated hot refueling system of the prior art;

FIG. 2 is a schematic plan view of one embodiment of a local fuel level-controlled hot refueling system at a wellsite;

FIG. 3 is a schematic of an embodiment of a local fuel level-controlled hot refueling system for a plurality of portable equipment, such as hydraulic fracturing pumpers at a wellsite;

FIG. 4 is a cross-sectional side view of a fuel tank for one of the plurality of pumpers of according to FIG. 3, the fuel tank having a fuel level controller adapted to access a fill opening of the fuel tank;

FIG. 5A is a partial side section view of a fuel tank with a float valve fuel level controller with the fuel tank at a low fuel level, the liquid level controller open for delivering fuel into the tank;

FIG. 5B is a partial side section view of the fuel tank of FIG. 5A with the float valve fuel level controller closed with the fuel tank at a pre-determined maximum fuel level; and

FIG. 6 is a process flow diagram of a fuel tank, such as that according to FIGS. 5A, 5B, applied to portable equipment in a hot zone and having a fuel level controller with fluid level sensing coupled to a shut off valve.

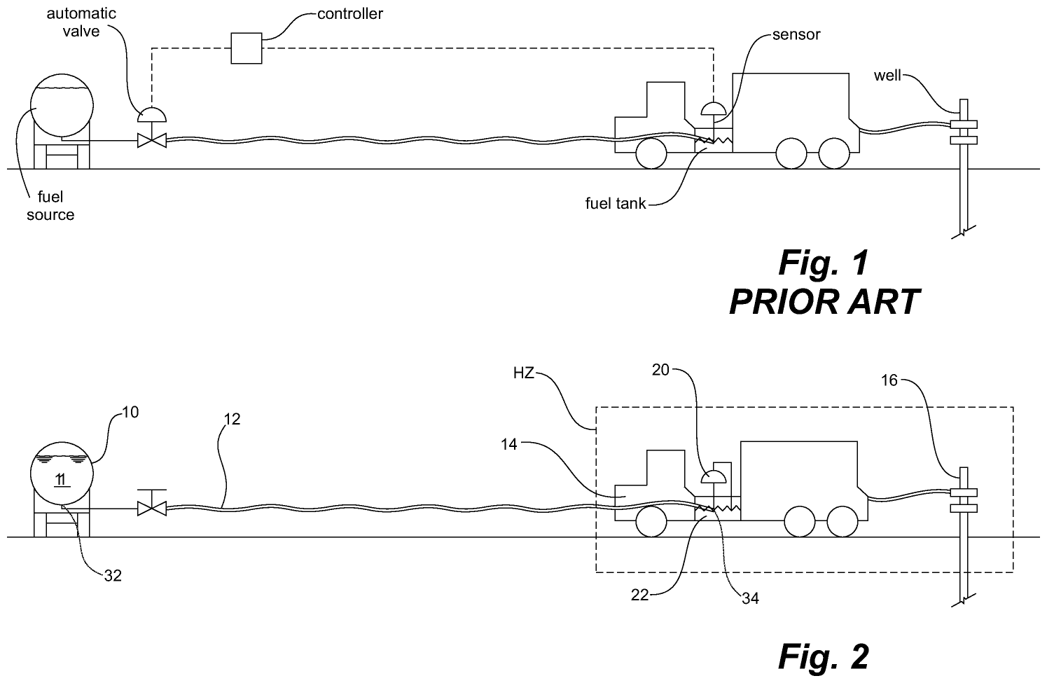

### DETAILED DESCRIPTION OF THE PREFERRED EMBODIMENTS

With reference to FIG. 2, a fuel source 10 of fuel 11 is connected to a conduit 12 that extends from the fuel source 10 to a fuel tank 22 that supplies a piece of equipment 14, the fuel tank 22 requiring periodic refueling during operation of the equipment 14. The present disclosure discloses a hot refueling system 8 that does not require a human operator to be in the hot zone HZ about at least the equipment 14 and can include a well 16. In other words, an individual need not be adjacent the running portable equipment 14 being refueled. Applicant's hot refueling system 8 uses automatically functioning valves 20, each located at its respective fuel tank 22, using local liquid level detection, and thus does not require a human operator, an electronic controller, nor remote operation to control automatically functioning valves and without the added components of a continuous circulation type system. Thus, as used herein, the term “automatic” or “automatically” refers to the opening and closing of a valve based on a fuel level detection mechanism integral with the valve, and not requiring control signals that are electrical, electronic, mechanical, electromechanical, electromagnetic or the like originating from a user or operator specifying or performing the opening or closing.

A well site for a hydraulic fracturing operation typically includes multiple pieces of portable equipment 14 for servicing the well 16, much or all of the equipment running, operating or otherwise consuming fuel, such as gasoline, diesel or natural gas. Each piece of portable equipment 14 uses one or more fuel tanks 22 having limited capacity balancing gross vehicle weight and operating duration before refueling. Shutting down equipment 14 for refueling purposes is disruptive to any operation and comes with economic and production cost. It is therefore desirable to refuel the equipment 14 while operating, known as “hot refueling”.

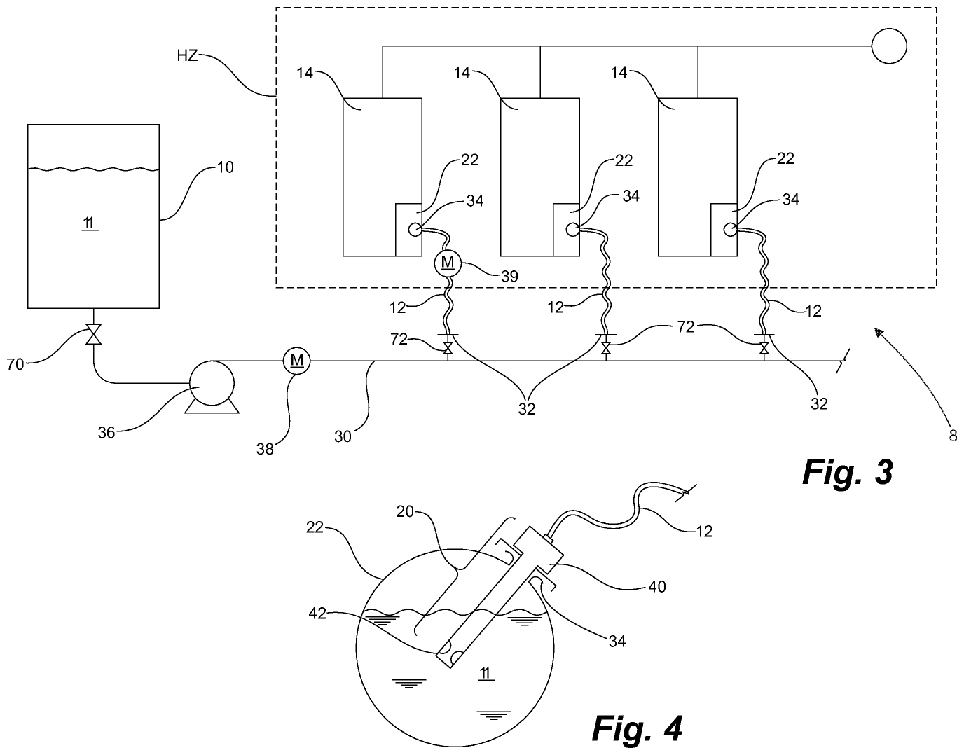

With reference also to FIG. 3, Applicant's hot refueling system 8 operates with one of the at least one fuel source 10, such as a fuel tank, located, or spaced, away from the portable equipment 14 and outside the hot zone HZ. The fuel source 10 may be mobile, for example, it may be attached to and transported by a vehicle (FIG. 2). As shown in the embodiment of FIG. 2, the fuel source 10 may comprise a fuel outlet 32 fluidly connected to a conduit 12 that can be extended to the fuel tank 22 of the equipment 14. Conduit 12 may be a hose, pipe, tube, or any other means of conveying fuel 11 from the fuel source 10 to the fuel tank 22, and is preferably flexible, and is preferably a hose. Conduit 12 is fluidly connected to an automatically functioning valve 20 which is adapted to a fuel inlet 34 of the fuel tank 22. As shown in the embodiment shown of FIG. 3, the fuel source 10 may comprise one or more manifolds 30 with associated manifold fuel outlets 32. Each manifold fuel outlet 32 is fluidly connected to a conduit 12 that can be extended to the fuel tank 22 of the equipment 14. At each piece of portable equipment 14 capable of refueling, the conduit 12 is fluidly connected to an automatically functioning valve 20 which is adapted to a fuel inlet 34 of the fuel tank 22. The automatically functioning valve 20 may further comprise a bi-directional venting port 35 equipped with a filter for venting excess air as the fuel tank 22 is filled with fuel 11 and for allowing additional air to enter the fuel tank 22 as the fuel level is lowered.

The hot refueling system 8 may provide for the delivery of fuel to multiple fuel tanks 22,22 . . . on multiple pieces of equipment 14,14 . . . at a well site during the servicing of a well. In other embodiments, the fuel source 10 comprises a single fuel outlet 32 for the delivery of fuel 11 to the fuel tank 22 of a single piece of equipment 14.

One or more pumps 36 may be included in the system 8 to aid in the delivery of the fuel 11 from the fuel source 10 through the conduits 12 to the automatically functioning valves 20 on each of the one or more fuel tanks 22,22 . . . . The pumps 36 may be pressure controlled to prevent excessive build-up of pressure or heat. For example, the pumps 36 could be shut off at 20 pounds per square inch (psi) and turned back on at 5 psi. A fluid meter 38 at the fuel source 10 can measure periodic or continuous fuel consumption. A fluid meter 38 can also be located at a fuel tank 22 to measure periodic or continuous fuel consumption for an individual fuel tank 22.

Turning to one embodiment of an automatically functioning valve 20, each valve 20 has a fluid inlet port 40 and a fluid outlet port 42. The inlet port 40 of the valve 20 is fluidly connected to the conduit 12 at the fuel tank 22. The outlet port 42 is fluidly connected to the inlet port 40, the valve 20 being situated therebetween for flow control therethrough. The automatically functioning valve 20 opens and closes based on the level FL of fuel 11 in the fuel tank 22.

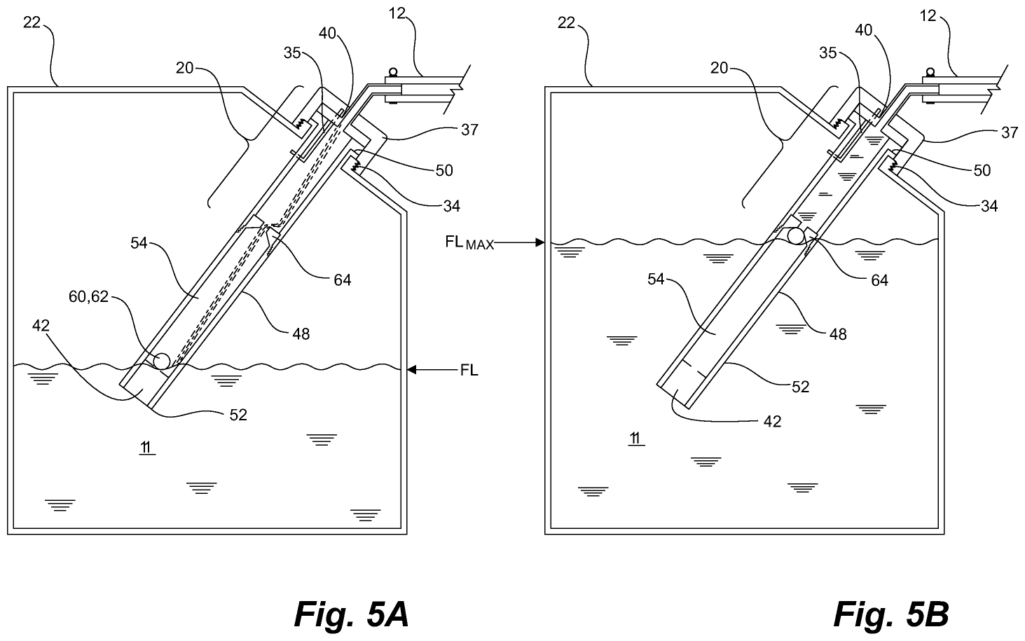

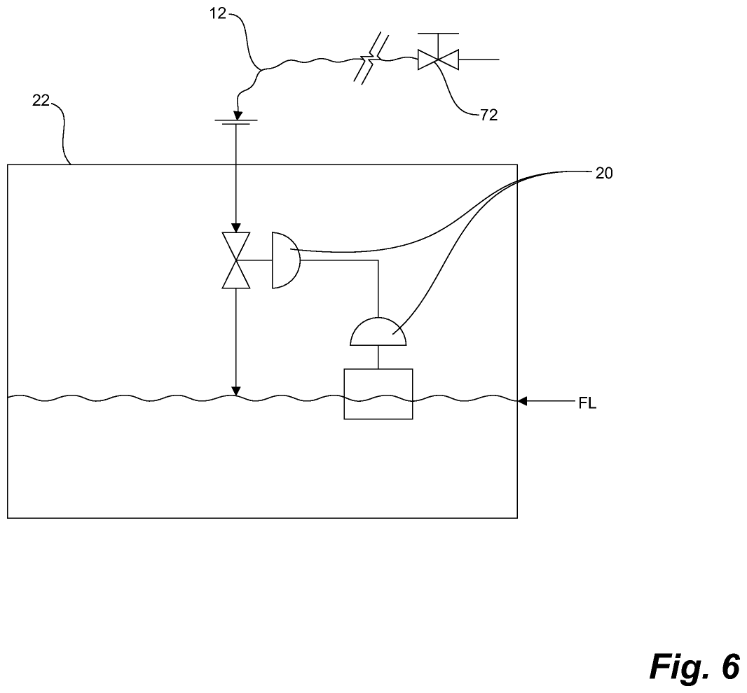

During operation, the automatically functioning valve 20 alternates between an open position (FIG. 5A), permitting fluid flow therethrough, and a closed position (FIG. 5B), preventing fluid flow therethrough. When the fuel level FL in the tank is below a specific maximum full fuel level threshold FL_{MAX}, the valve 20 is in open position. When the fuel level in the tank is at or above the full fuel level threshold, the valve is in the closed position. The valve will automatically switch from an open to a closed position and from a closed to open position depending on the fuel level.

If fuel 11 is continuously provided through the conduit 12 to the fuel tank 22, the operation of the automatically functioning valve 20 causes the fuel level FL to be maintained around the full fuel level threshold FL_{MAX}.

With reference to FIGS. 5A and 5B, as shown, in one embodiment, the automatically functioning valve is a float-type valve connected at an upper end to the conduit 12. The float-type valve is generally a tubular conduit 48 fit with the inlet port 40 adjacent or at an upper end 50 and the outlet port 42 adjacent or at a lower end 52. A conduit bore 54 extends between the inlet and outlet ports 40,42. The conduit 48 is installed with a downward slope into the fuel tank 22 with the inlet port 40 at an elevation above the outlet port 42. Between the inlet port 40 and the outlet port 42, there is a float mechanism 60 comprising a float, or ball 62, that moves freely in the bore 54 vertical axis between a minimum level and a maximum level FL_{MAX}. The minimum level is above at least the bottom of the outlet port 42 to retain the float therein and the maximum level FL_{MAX} is below the inlet port 40. The float mechanism 60 moves as a result of buoyant forces acting on the float in fuel. When open, fuel 11 flows from the conduit 12, through inlet port 40, along the conduit bore 54, past the ball 62 and through the outlet port 42. As the fuel level FL increases, ball 62 moves up the bore of the conduit 48. Fuel 11 continues to flow until the fuel level FL reaches the full fuel level threshold FL_{MAX} whereupon the ball engages a seat 64 forming a seal in the valve and shutting off fuel flow. In embodiments, the conduit 48 is armored and flexible.

Float-type valves 20 are known and have been used in many applications in different fields involving filling vessels with liquid. An example of a suitable float-type valve in the applicant's system 8 is the model PLA80-SVLC valve from FuelHawk Equipment Ltd., featuring automatic independent tank shutoff.

The FuelHawk PLA80-SVLC valve is designed for refueling in the oil extraction environment and includes features such as pressure balance and overfilling prevention. Overfilling prevention is achieved by automatically shutting off the fuel flow at between 90% and 95% of fuel capacity.

The valve 20 may also be a pressure controlled valve that operates based on the pressure in the fuel tank 22 (pressure correlating with fuel level), or an electronic level sensor controlled valve that operates based on the fuel level in the fuel tank 22.

The hot refueling system 8 may comprise multiple fuel sources 10,10 . . . and from each source 10, a manifold 30 or other system may be used to connect multiple fuel sources 10,10 to the fuel outlets 32,32 of the system 8. The fuel sources 10 may each have independently controllable shut off valves 70 and pumps 36 so the fuel sources can be used by the system 8 simultaneously or selectively.

The automatically functioning valve 20 is situated at the fuel tank 22 at the fuel inlet 34. The fuel inlet 34 is typically closed with a fuel cap 37 that is removed to access the fuel tank 22. The valve is fit to the fuel inlet 34 for delivery of fuel thereto and which can limit admission of contaminants to the fuel tank 22, and limiting fuel spills under normal operation.

For commercial refueling convenience, the fuel inlets 34 on fuel tanks typically use one of a few common connection types and sizes. The valve 20 is compatible in size with the fuel inlet 34 and can include coupling adaptors to better fit the valve thereto.

In an embodiment shown in FIG. 3, a manual shut-off valve 70 is provided at the fuel source 10. In another embodiment, or in addition, manual shut off valves 72 can be provided at each fuel outlet 32 to shut off flow to a fuel tank 22 through a corresponding conduit 12, such as to close unused lines or to unused equipment. The use of manual shut off valves 72 can aid in adding, changing or removing equipment fuel tanks 22 from the system 8.

The system 8 can comprise gauges and meters including at or proximate to the fuel source 10 or the fuel tanks 22, 22 to measure such information as fuel pressure, rate of flow and fuel consumption. The rate of flow gauge or meter can log a period of flow rates, a peak flow rate or an average flow rate.

In an embodiment, a fluid meter 38 is provided for each fuel source 10. The meter 38 measures the volume of fluid flowing therethrough and can be either mechanical or electronic.

In an embodiment, a fluid meter 38 is provided for each fuel tank 22. The meter 38 can be located proximate to the fuel source 10, proximate to the fuel tank 22 or any location therebetween including either inside or outside the hot zone HZ.

In an embodiment, the hot refueling system 8 is controlled by a time-based controller that has fixed operational periods, where the system 8 is refueling, and fixed non-operational periods, where the system 8 is not refueling, within operating cycles.

In an embodiment, the hot refueling system 8 is used in an application wherein equipment 14 is run and required for two hours intervals. In the embodiment, the time-based controller would turn on the system 8 for two hour intervals.

In an embodiment, the fuel tank 22 of the equipment 14 in a particular application is capable of supplying the equipment 14 with fuel for period of time (T) without requiring refueling. To increase energy efficiency, the system 8 is controlled by a time-based controller that runs the system through at least one cycle for each period of time T.

The automatically functioning valve repetitively alternates between the open and closed positions. As the hot refueling method allows portable equipment to run continuously, such as in a hydraulic fracturing operation, without the safety concerns associated with having persons in the hot zone HZ, the portable equipment used can be outfitted with smaller capacity tanks, reducing the gross vehicle weight for transport. The portable equipment can arrive at the hydraulic fracturing site with the fuel tanks depleted and the hot refueling system 8 set up prior to commencement of the hydraulic fracturing operation.

When the portable equipment is operated continuously, as long as the fuel source is open to the conduits 12,12 . . . the fuel tanks 22 are automatically kept near their respective full fuel level thresholds. The method for hot refueling may also be run periodically with a time-based controller coupled at the fuel source. The duration of the operating and non-operating cycles of the hot refueling method is based on the amount of or rate at which the portable equipment needs to be refueled. The state of the operating and non-operating cycles is not related to the automatic functioning of the valves 20,20 . . . in the hot zone HZ.

While the system and method have been described in conjunction with the disclosed embodiments and examples which are set forth in detail, it should be understood that this is by illustration only and the system and method are not intended to be limited to these embodiments. On the contrary, this disclosure is intended to cover alternatives, modifications, and equivalents which will become apparent to those skilled in the art in view of this disclosure.

The embodiments of the invention for which an exclusive property or privilege is claimed are defined as follows:

1. A hot refueling system for refueling a fuel tank of operating equipment at a well site comprising:
a fuel source comprising at least one fuel source outlet;
a conduit extending from the at least one fuel source outlet to a fuel tank inlet of the fuel tank, for delivery of fuel to the fuel tank; and
the fuel tank inlet comprising a valve that has an open position allowing a flow of fuel into the fuel tank when fuel level in the fuel tank is below a full fuel level threshold and a closed position preventing the flow of fuel into the fuel tank when fuel level in the fuel tank is at or above the full fuel level threshold, wherein the valve automatically cycles between the open position and the closed position in response to fuel level in the fuel tank.

2. The system of claim 1, further comprising a plurality of fuel tanks and a plurality of conduits wherein the fuel source comprises a manifold having two or more fuel source outlets, and wherein one of the plurality of conduits extends from each fuel source outlet to an inlet of one of the plurality of fuel tanks.

3. The system of claim 1, further comprising a pump to deliver fuel from the fuel source to the fuel tank.

4. The system of claim 1, wherein the conduit is armored and flexible.

5. The system of claim 1, wherein the valve is a float-type valve that comprises a float responsive to fuel level in the fuel tank, wherein the valve closes when the float is at or above the full fuel level threshold and opens when the float is below the full fuel level threshold.

6. The system of claim 5, wherein the valve comprises a conduit extending into the fuel tank inlet, the conduit restraining the float therein and further comprising a seat, the float sealing the seat when fuel level is at or above the full fuel level threshold.

7. The system of claim 1, wherein the valve is a pressure-sensitive valve responsive to pressure in the fuel tank, wherein the valve closes at or above a pressure corresponding to the full fuel level threshold and opens at a pressure below the pressure corresponding to the full fuel level threshold.

8. The system of claim 1, wherein the fuel source further comprises a manual valve arrangement located outside of the hot zone, to shut off the flow of fuel into the at least one conduit.

9. The system of claim 2, wherein each fuel outlet comprises a manual valve arrangement located outside of the hot zone, to shut off the flow of fuel into a conduit extending therefrom.

10. The system of claim 1, further comprising a manifold connecting a plurality of fuel sources to the fuel source outlet.

11. The system of claim 1, further comprising a manual fluid flow meter for the fuel source.

12. The system of claim 1, further comprising a manual fluid flow meter for the fuel tank.

13. The system of claim 1, further comprising a rate of flow meter for the fuel tank.

14. The system of claim 1 further comprising a fuel pressure sensor for the fuel tank.

15. The system of claim 1, further comprising a time-based controller that controls the flow of fuel from the fuel source to the fuel tank on a time schedule.

16. The system of claim 1, wherein the full fuel level threshold is between 90% to 95% of a physical capacity of the fuel tank.

17. A method of delivering fuel to at least one fuel tank of equipment at a well site, the method comprising:
pumping fuel from a fuel source into a conduit and from the conduit into the at least one fuel tank;
controlling fluid flow from the conduit into the at least one fuel tank with a valve that is responsive to fuel level in the fuel tank,
wherein the valve automatically opens when fuel level in the fuel tank is below a full fuel level threshold and automatically closes when fuel level in the fuel tank is at or above the full fuel level threshold.

18. The method of claim 17, wherein the fuel is pumped at a specified time for a specified duration.

19. The method of claim 17, wherein fuel is pumped periodically for a specified time followed by a user specified delay.

20. The method of claim 17, wherein the full fuel level threshold is set between 90% to 95% of the physical capacity of the at least one fuel tank.
